(19) United States
(12) Patent Application Publication
(10) Pub. No.: US 2008/0200638 A1
(43) Pub. Date: Aug. 21, 2008

(54) Bioresorbable Composites and Method of Formation Thereof

(76) Inventor: Jody Redepenning, Lincoln, NE (US)

Correspondence Address: HUSCH BLACKWELL SANDERS LLP, 1620 DODGE STREET, SUITE 2100, OMAHA, NE, 68102, US

(21) Appl. No.: 11/658,920

(22) PCT Filed: Aug. 1, 2005
(86) PCT No.: PCT/US05/27257

§ 371 Date: Mar. 28, 2008

Related U.S. Application Data
(60) Provisional application No. 60/592,714, filed on Jul. 30, 2004.

(51) Int. Cl. C08G 63/08

(52) U.S. Cl. 528/286; 528/356

(57) ABSTRACT

A composite comprising a bioabsorbable polymer or copolymer of a lactone monomer or mixture thereof and a ceramic, the composite having been prepared by the ceramic initiated ring-opening polymerization or copolymerization of the lactone monomer, wherein the ceramic is an apatitic calcium phosphate or an osteoconductive, bioabsorbable derivative thereof and a method of manufacture thereof.

This patent application claims the benefit of U.S. Provisional Application No. 60/592,714 filed Jul. 30, 2004, the entire contents and disclosure of which are incorporated herein by reference.

### FIELD OF THE INVENTION

The present invention relates to implants for bone repair and replacement, and more particularly to polymer-apatitic calcium phosphate composites.

### BACKGROUND OF THE INVENTION

The successful design of a prosthetic device to replace or repair skeletal tissue requires knowledge of the structure and mechanical properties of bone and an understanding of the means by which such prostheses become incorporated into the body. This information can then be used to define desirable characteristics of the implant to ensure that the graft functions in a manner comparable to organic tissue.

The mechanical properties of bone are related to the internal organization of the material, as reviewed by Roesler, H., “The History of Some Fundamental Concepts in Bone Biomechanics,” Journal of Biomechanics, 20, 1025-34 (1987). Cortical bone is classified as a material of less than 30% porosity, as described by Keaveny, T. M. and W. C. Hayes, “Mechanical Properties of Cortical and Trabecular Bone,” in Bone Volume 7: Bone Growth-B, B. K. Hall, ed., Boca Raton: CRC Press, 285-344 (1992), as a “solid containing a series of voids (Haversian canals, Volkmann's canals, lacunae and canaliculi). The porosity of cortical bone tissue (typically 10%) is primarily a function of the density of these voids.” In contrast, cancellous/trabecular bone is “a network of small, interconnected plates and rods of individual trabeculae with relatively large spaces between the trabeculae.” Trabecular bone has a porosity of 50-90% which is a function of the space between the trabeculae.

The material properties of bone are based on determinations of the elastic modulus, compressive and tensile strengths. As a general rule, bone is stronger in compression than in tension and cortical is stronger than trabecular bone. Ranges of reported elastic modulus have been from 10 MPa to 25 GPa (10 MPa to 2 GPa for cancellous bone; 4 to 25 GPa for cortical and cancellous bone); compressive strength between 40 and 280 MPa (40 to 280 MPa for cancellous bone; 138 to 193 MPa for cortical bone); and tensile strength between 3.5 MPa and 150 MPa (3.5 to 150 MPa for cancellous bone; 69 to 133 MPa for cortical bone) (Friedlaender and Goldberg, Bone and Cartilage Allografts Park Ridge: American Academy of Orthopedic Surgeons 1991; Jarcho, “Calcium Phosphate Ceramics as Hard Tissue Prosthetics” Clin. Orthopedics and Related Research 157, 259-278 1981; Gibson, “The Mechanical Behavior of Cancellous Bone” J. Biomechan. 18(5), 317-328 1985; Keaveny and Hayes 1992).

Mechanisms by which bone may fail include brittle fracture from impact loading and fatigue from constant or cyclic stress. Stresses may act in tension, compression, or shear along one or more of the axes of the bone. A synthetic bone substitute must resist failure by any of these stresses at their physiological levels. A factor of safety on the strength of the implant may ensure that the implant will be structurally sound when subject to hyperphysiological stresses.

A graft may be necessary when bone fails and does not repair itself in the normal amount of time or when bone loss occurs through fracture or tumor. Bone grafts must serve a dual function: to provide mechanical stability and to be a source of osteogenesis. Since skeletal injuries are repaired by the regeneration of bone rather than by the formation of scar tissue, grafting is a viable means of promoting healing of osseous defects, as reviewed by Friedlaender, G. E., “Current Concepts Review: Bone Grafts,” Journal of Bone and Joint Surgery, 69A(5), 786-790 (1987). Osteoinduction and osteoconduction are two mechanisms by which a graft may stimulate the growth of new bone. In the former case, inductive signals of little-understood nature lead to the phenotypic conversion of connective tissue cells to bone cells. In the latter, the implant provides a scaffold for bony ingrowth.

The bone remodeling cycle is a continuous event involving the resorption of pre-existing bone by osteoclasts and the formation of new bone by the work of osteoblasts. Normally, these two phases are synchronous and bone mass remains constant. However, the processes become uncoupled when bone defects heal and grafts are incorporated. Osteoclasts resorb the graft, a process which may take months. More porous grafts revascularize more quickly and graft resorption is more complete. After graft has been resorbed, bone formation begins. Bone mass and mechanical strength return to near normal.

Present methods for the repair of bony defects include grafts of organic and synthetic construction. Three types of organic grafts are commonly used: autografts, allografts, and xenografts. An autograft is tissue transplanted from one site to another in the patient. The benefits of using the patient's tissue are that the graft will not evoke a strong immune response and that the material is vascularized, which allows for speedy incorporation. However, using an autograft requires a second surgery, which increases the risk of infection and introduces additional weakness at the harvest site. Further, bone available for grafting may be removed from a limited number of sites, for example, the fibula, ribs and iliac crest. An allograft is tissue taken from a different organism of the same species, and a xenograft from an organism of a different species. The latter types of tissue are readily available in larger quantities than autografts, but genetic differences between the donor and recipient may lead to rejection of the graft.

Synthetic implants may obviate many of the problems associated with organic grafts. Further, synthetics can be produced in a variety of stock shapes and sizes, enabling the surgeon to select implants as his needs dictate, as described by Coombes, A. D. A. and J. D. Heckman, “Gel Casting of Resorbable Polymers: Processing and Applications,” Biomaterials, 13(4), 217-224 (1992). Metals, calcium phosphate ceramics and polymers have all been used in grafting applications.

Calcium phosphate ceramics are used as implants in the repair of bone defects because these materials are non-toxic, non-immunogenic, and are composed of calcium and phosphate ions, the main constituents of bone, in an apatitic structure (Jarcho, 1981; Frame, J. W., “Hydroxyapatite as a biomaterial for alveolar ridge augmentation,” Int. J. Oral Maxillofacial Surgery, 16, 642-55 (1987); Parsons, et al. “Osteoconductive Composite Grouts for Orthopedic Use,” Annals N.Y. Academy of Sciences, 523, 190-207 (1988)). Both tricalcium phosphate (TCP) [Ca₃(PO₄)₂] and bydroxyapatite (HA) [Ca₁₀(PO₄)₆(OH₂] have been widely studied for this reason. Calcium phosphate implants are osteoconductive, and have the apparent ability to become directly bonded to bone, as reported by Jarcho 1981. As a result, a strong bone-implant interface is created.

Calcium phosphate ceramics have a degree of bioresorbability which is governed by their chemistry and material structure. High density HA and TCP implants exhibit little resorption, while porous ones are more easily broken down by dissolution in body fluids and resorbed by phagocytosis. However, TCP degrades more quickly than HA structures of the same porosity in vitro. In fact, HA is relatively insoluble in aqueous environments. The use of calcium phosphates in bone grafting has been investigated because of the chemical similarities between the ceramics and the mineral matrix found in the teeth and bones of vertebrates. This characteristic of the material makes it a good candidate as a source of osteogenesis. However, the mechanical properties of calcium phosphate ceramics make them ill-suited to serve as a structural element. Ceramics are brittle and have low resistance to impact loading.

Biodegradable polymers are used in medicine as suture and pins for fracture fixation. These materials are well suited to implantation as they can serve as a temporary scaffold to be replaced by host tissue, degrade by hydrolysis to non-toxic products, and be excreted, as described by Kulkarni, et al., J. Biomedical Materials Research, 5, 169-81 (1971); Hollinger, J. O. and G. C. Battistone, “Biodegradable Bone Repair Materials,” Clinical Orthopedics and Related Research, 207, 290-305 (1986).

Four polymers widely used in medical applications are poly(paradioxanone) (PDS), poly(lactic acid) (PLA), poly(glycolic acid) (PGA), and PLAGA copolymers. Copolymerization enables modulation of the degradation time of the material. By changing the ratios of crystalline to amorphous polymers during polymerization, properties of the resulting material can be altered to suit the needs of the application. For example, PLA is crystalline and a higher PLA content in a PLAGA copolymer results in a longer degradation time, a characteristic which may be desirable if a bone defect requires structural support for an extended period of time. Conversely, a short degradation time may be desirable if ingrowth of new tissue occurs quickly and new cells need space to proliferate within the implant.

Coombes and Heckman 1992 and Hollinger 1983 have attempted to create poly(lactide-co-glycolide) [(C₃H₄O₂)ₓ(C₂H₂O₂)_{y}] implants as bone substitute. Hollinger used a PLAGA of high inherent viscosity (0.92 dl/g) prepared by a solvent-non-solvent casting method. Plugs of this material were implanted in tibial defects of Walter Reed rats, and humoral defects were created as control sites in which no polymer was implanted. Examination of the defects after sacrifice of the animals at 7, 14, 21, 28 and 42 days suggested that polymer may aid in osteoinduction in the early bone repair process. However, by 42 days, the rate of repair was equivalent in controls and experimental defect sites. Coombes and Heckman described a gel casting method for producing a three-dimensional PLAGA matrix. Success of this method, i.e., creation of a strong, rubbery gel, was dependent upon high inherent viscosity of the polymer (0.76-0.79 dl/g). Material properties of the polymer matrix through a degradation cycle were the focus of the research. The modulus of the PLAGA implant before degradation was 130 MPa, equivalent to that of cancellous bone. After eight weeks degradation in phosphate buffered saline (PBS), the strength of the material had deteriorated significantly. Moreover, the microporous structure (pores 205 .mu.m in diameter) has been shown to be too small to permit the ingrowth of cells, as reported by Friedlaender and Goldberg 1991 and Jarcho 1981. From a mechanical as well as a biological standpoint, this matrix is not ideal for use as a substitute bone graft material.

Other workers in this field have formed composites of various forms of hydroxyapatite and numerous polymers or other supplementary materials such as, e.g., collagen, glycogen, chitin, celluloses, starch, keratins, silk, nucleic acids, demineralized bone matrix, derivativized hyaluronic acid, polyanhydrides, polyorthoesters, polyglycolic acid, polylactic acid, and copolymers thereof. In particular, polyesters of alpha-hydroxycarboxylic acids, such as poly(L-lactide) (PLLA), poly(D,L-lactide) (PDLLA), polyglycolide (PGA), poly(lactide-co-glycolide (PLGA), poly(D,L-lactide-co-trimethylene carbonate), and polyhydroxybutyrate (PHB), and polyanhydrides, such as poly(anhydride-co-imide) and co-polymers thereof are known to bioerode and are suitable for use in the present invention. In addition, bioactive glass compositions, such as compositions including SiO₂, Na₂O, CaO, P₂O₅, Al₂O₃ and/or CaF₂, may be used. Other useful bioerodible polymers may include polysaccharides, peptides and fatty acids.

Bioerodible polymers are advantageously used in the preparation of bioresorbable hardware, such as but not limited to intermedulary nails, pins, screws, plates and anchors for implantation at a bone site. In preferred bioresorbable hardware embodiments, the supplementary material itself is bioresorbable and is added to the PCA calcium phosphate in particulate or fiber form at volume fractions of 1-50% and preferably, 1-20 wt %. In some preferred embodiments, the bioresorbable fiber is in the form of whiskers which interact with calcium phosphates according to the principles of composite design and fabrication known in the art. Such hardware may be formed by pressing a powder particulate mixture of the PCA calcium phosphate and polymer. In one embodiment, a PCA calcium phosphate matrix is reinforced with PLLA fibers, using PLLA fibers similar to those described by Tormala et al., which is incorporated herein by reference, for the fabrication of biodegradable self-reinforcing composites (Clin. Mater. 10:29-34 (1992)).

The implantable bioceramic composite may be prepared as a paste by addition of a fluid, such as water or a physiological fluid, to a mixture of a PCA calcium phosphate and a supplemental material Alternatively, a mixture of the supplementary material with hydrated precursor powders to the PCA calcium phosphate can be prepared as a paste or putty. In cases where the supplementary material is to be dispersed within or reacted with a PCA calcium phosphate matrix, water may be added to one of the precursor calcium phosphates to form a hydrated precursor paste, the resulting paste is mixed with the supplementary material, and the second calcium phosphate source is then added. Alternatively, the calcium phosphate sources which make up the PCA calcium phosphate precursor powder may be premixed, water may then be added and then the supplementary material is added. In those cases where it is desirable to have the supplementary material serve as the matrix, the fully hardened PCA calcium phosphate will be prepared in the desired form which will most often be of controlled particle size, and added directly to the matrix forming reaction (e.g., to gelling collagen). These materials may then be introduced into molds or be otherwise formed into the desired shapes and hardened at temperatures ranging from about 35-100° C. A particularly useful approach is to form the composite precursor paste into the approximate shape or size and then harden the material in a moist environment at 37° C. The hardened composite may then be precisely milled or machined to the desired shape for use in the surgical setting. The amount of particular PCA calcium phosphate to be incorporated into the supplemental material matrix will most often be determined empirically by testing the physical properties of the hardened composite according to the standards known to the art.

It is an object of the invention to provide novel bioresorbable composites comprising an apatitic calcium phosphate and a compatible polymer.

It is a further object of the invention to provide a novel method for forming such composites.

It is a further object of the invention to provide articles of manufacture comprising the composites.

### SUMMARY OF THE INVENTION

The above and other objects are realized by the present invention, one embodiment of which relates to a composite comprising a bioabsorbable polymer or copolymer of a lactone monomer or mixture thereof and a ceramic, the composite having been prepared by the ceramic initiated ring-opening polymerization or copolymerization of the lactone monomer, wherein the ceramic is an apatitic calcium phosphate or an osteoconductive, bioabsorbable derivative thereof.

A further embodiment of the invention concerns a method of preparing a composite comprising a bioabsorbable polymer or copolymer of a lactone monomer or mixtures thereof and a ceramic, comprising polymerizing or copolymerizing the lactone monomer by ring-opening polymerization initiated by the ceramic, wherein the ceramic is an apatitic calcium phosphate or an osteoconductive, bioabsorbable derivative thereof.

An additional embodiment of the invention is to provide an article of manufacture comprising the above-described composite.

### BRIEF DESCRIPTION OF THE DRAWINGS

FIG. 1 is a ¹H NMR spectrum of a typical product of the invention.

FIG. 2 is depicts the kinetics of lactide polymerization.

FIG. 3 pictures a resorbable bone fixation screw according to the invention.

FIG. 4 is an SEM image of composite according to the invention.

FIG. 5 is a depiction of representative compressive stress-strain curves for HA/polylactide composites of the invention.

### DETAILED DESCRIPTION OF THE INVENTION

The present invention is predicated on the discovery that a superior bioresorbable composite comprising an apatitic calcium phosphate or suitable derivative thereof and certain polymers comprising specific lactones may be formed by the ring-opening polymerization of the lactone, either alone or in the presence of monomers suitable for copolymerization therewith, in the presence of the apatitic calcium phosphate which initiates the ring-opening polymerization. The resulting product is a composite containing the apatitic calcium phosphate completely entrapped within the polymeric matrix.

The lactone monomers that may be polymerized or copolymerized according to the method of the invention include those having the formula:

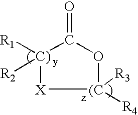

wherein X=nil, —O—, or —O—C═O; z=1-3; y=1-4; R₁-R₄=H—, C₁-C₁₆ straight or branched chain alkyl group, or HOCH₂—, and where all R's are independent on each y or z carbon atom and independent of each other; or

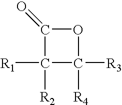

wherein R₁-R₄=H—, C₁-C₁₆ straight or branched chain alkyl group, or HOCH₂—, and where all R's are independent of each other.

Suitable lactone monomers that may be employed in the practice of the invention include any that form a bioabsorbable polymer or copolymer such as, but not limited to caprolactone, t-butyl caprolactone, zeta-enantholactone, deltavalerolactones, the monoalkyl-delta-valerolactones, e.g., the monomethyl-, Monoethyl-, monohexyl-deltavalerolactones, and the like; the nonalkyl, dialkyl, and trialkyl-epsilon-caprolactones, e.g., the monomethyl-, monoethyl-, monohexyl-, dimethyl-, di-n-propyl-, di-n-hexyl-, trimethyl-, triethyl-, tri-n-epsilon-caprolactones, 5-nonyl-oxepan-2-one, 4,4,6- or 4,6,6-trimethyl-oxepan-2-one, 5-hydroxymethyl-oxepan-2-one, and the like; beta-lactones, e.g., beta-propiolactone, beta-butyrolactone gamma-lactones, e.g., gammabutyrolactone or pivalolactone, dilactones, e.g., lactide, dilactides, glycolides, e.g., tetramethyl glycolides, alkyl derivatives thereof and the like, ketodioxanones, e.g. 1,4-dioxan-2-one, 1,5-dioxepan-2-one, and the like. The lactones can consist of the optically pure isomers or two or more optically different isomers or can consist of mixtures of isomers.

The ceramic employed in the practice of the invention is any that will initiate the ring-opening polymerization of any of the above lactones, such as, but not limited to apatitic calcium phosphates or osteoconductive, bioabsorbable derivatives thereof. Suitable apatitic calcium phosphates include but are not limited to hydroxyapatite [Ca₁₀(PO₄)₆(OH)2], tribasic calcium phosphate [Ca3(PO4)2, bone ash, bone phosphate, tertiary calcium phosphate, tricalcium phosphate, whillockite] and the like or mixtures thereof. Suitable derivatives of apatitic calcium phosphates include but are not limited to osteoconductive, bioabsorbable hydroxyapatites capable of initiating ring-opening polymerization of the lactone that have been OH-exchanged with oxide, alkoxide or alkonoic acid, such as, but not limited to alkoxide, e.g., methoxide or ethoxide or alkanoic acid such as octanoic acid.

The composites of the invention are of interest for hard tissue replacement and fixation (bone fixation plates, pins, bars, plates and screws. There is no tissue reaction due to corrosion byproducts often associated with metal devices. Such compositions exhibit mechanical properties (compressive strength and elastic modulus) that approach those of living bone. Furthermore, these composites are not as hard or as brittle as ceramic materials often used for implants.

Another advantage of the composites of the invention and the methods for their preparation include is the fact a significant fraction of the living anion of the polymerization reaction is electrostatically bound to the ceramic. Consequently, there is improved interfacial strength between the ceramic and polymer. Interfacial strength is often limited when an inorganic compound or ceramic is merely admixed with an already formed organic polymer. The fact that the composites are produced in a single step and that no solvent is required to prepare the composite or process it is another unexpected advantage. The inorganic component of the composite, which is dispersed in the liquid phase monomer, serves as the polymerization initiator. The HA initiator can be removed easily from the polymer product and both the chemistry and the processing are environmentally benign. The macroscopic shape of the composites is determined by the shape of cast in which the polymerization occurs, or by standard machining techniques.

The process of the invention for manufacturing the composites is relatively simple, inexpensive, and can be carried out on large scales. The ceramic attacks the lactone ring and opens it. The resulting “living anion” acts as a nucleophile to open another lactone ring, and the process repeats itself to propagate the polymerization until a chain-terminating step occurs.

### EXAMPLE 1

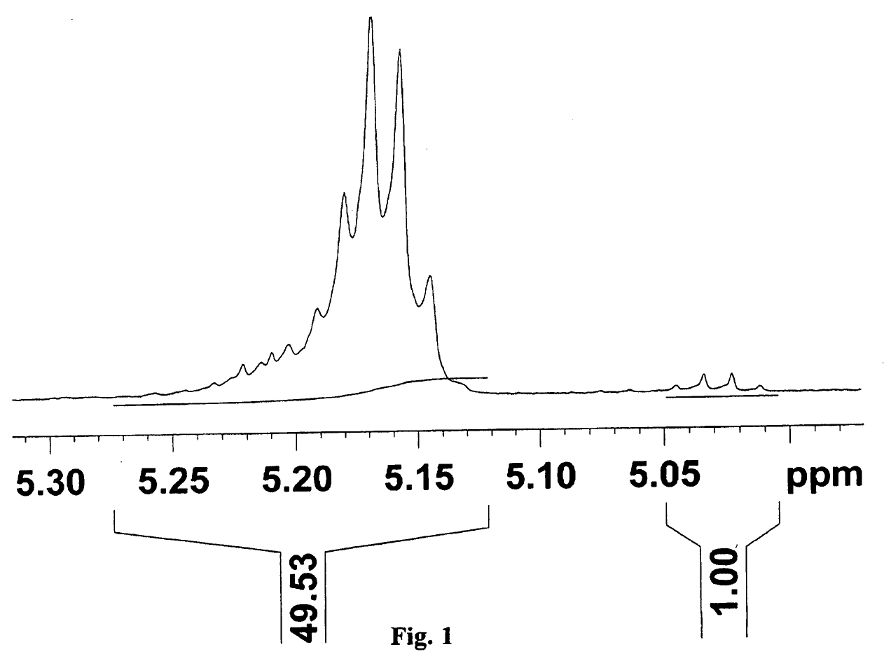

A composite was produced by heating a 2:1 mixture (by weight) of lactide and HA in a sealed tube at 120° C. for 12 hours. FIG. 1 shows a ¹H NMR spectrum of the organic constituents found therein. The resonances centered at a chemical shift of approximately 5.18 ppm are characteristic of isotactic poly-L-lactide, while the small peaks at approximately 5.24 ppm are indicative of a small amount of atactic poly-L-lactide. The resonances at approximately 5.06 ppm indicate that approximately 2-5% of the monomer remains unreacted. A conventional initiator of lactide polymerization, stannous 2-ethylhexanoate gives a similar conversion to polymer when the reaction is carried out in a melt. ¹H NMR spectra such as the one shown in FIG. 1 can be used to characterize the kinetics of the ring-opening event that occurs at the interface between hydroxyapatite and molten lactide.

### EXAMPLE 2

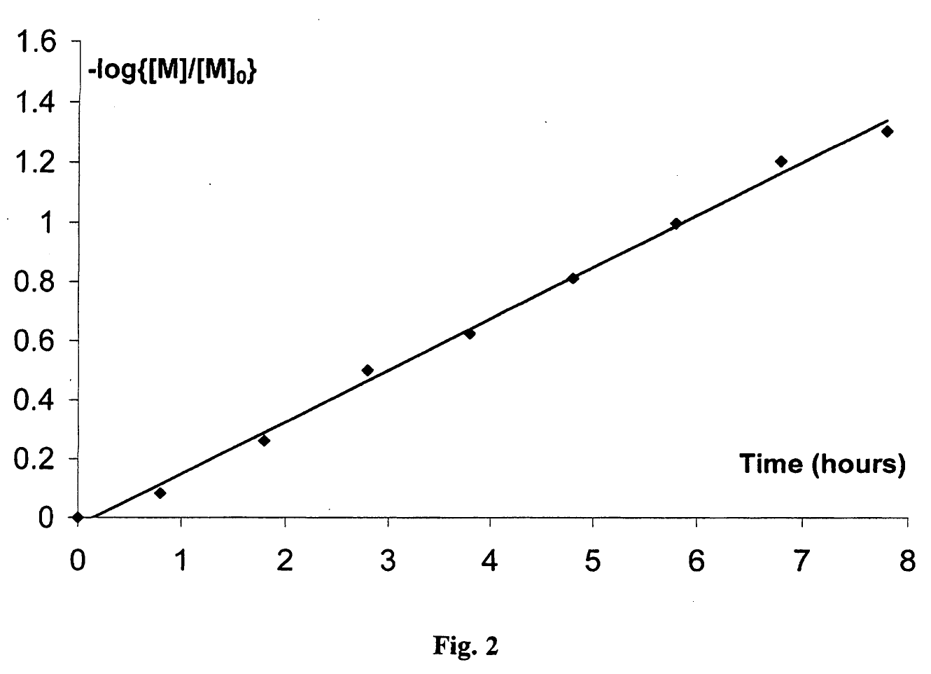

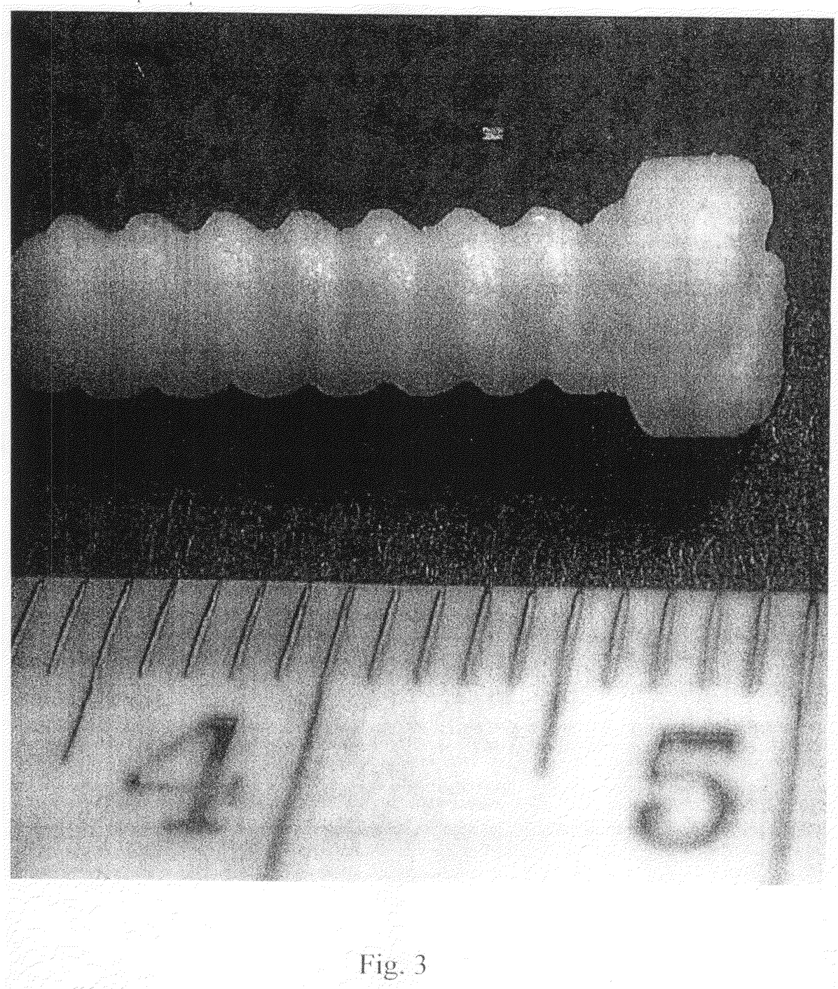

The results of a preliminary kinetics experiment are shown in FIG. 2. In this particular experiment a 2:1 mixture (by weight of lactide:HA was heated in a sealed tube at 130° C. Aliquots of the reaction mixture were removed and thermally quenched at regular intervals. The polymer was then extracted into CHCl_{3, and} ¹H NMR spectra of the extracted polymer samples were used to determine the fraction of lactide that remained in the reaction mixture as a function of time. In FIG. 2, the logarithm of [M]/[M]₀ where [M]₀ is the original concentration of monomer and [M] is the concentration of monomer at a t>0, is plotted. versus time.

The results shown in FIG. 2 are a good indicator that the kinetics of this class of reactions are successful. The uncertainty in the results is not excessive; furthermore the linearity of the results as displayed in FIG. 2 is highly informative. The zero intercept and the linear time dependence of log {[M]/[M]o} is indicative of a first order kinetic equation, i.e.,

$$- \frac{d [ M ]}{d t} = {k}_{app} [ M ]$$

where kₐₚₚ is the apparent first order rate constant, and where the integrated form of the rate expression is

$$- ln \frac{[ M ]}{{[ M ]}_{0}} = {k}_{app} t or - log \frac{[ M ]}{{[ M ]}_{0}} = {k}_{app} t / 2.303$$

It is be noted that in order for the first-order kinetic model to fit, there must be no induction period before the HA initiator becomes active. An induction period involving slow steps prior to chain initiation would manifest itself in a nonzero intercept in plots of log {[M]/[M]ₒ} vs. time. Moreover, the linearity of the plots at t>0 indicates that the number of chain propagating chains remains constant during the course of the reaction. In other words, no chain terminating steps are evident on this time scale. In short, HA-initiated polymerization of lactide gives non-terminated or “living” polymers with readily interpretable kinetic parameters.

### EXAMPLE 3

Following the above procedures, bydroxyapatite was used to initiate the polymerization of glycolide, E-caprolactone and an 82:18 ratio of lactide:glycolide using the same one-step procedure used for lactide. The goal here has been to demonstrate that hydroxyapatite can also be used to polymerize (and form composites with) other cyclic lactones relevant to biomaterials research. NMR was used to establish that the polymerization was successful.

### EXAMPLE 4

A screw was machined from a rod of HA/PLA composite prepared using the using the synthetic procedure outlined above. The screw pictured in FIG. 3 is modeled after the polylactide SMARTCREWT™, sold by Linvatec, Inc. This screw was machined from a 0.65 cm diameter rod that was cast from a melt prepared by heating a 1:2 mixture of HA:Lactide at 130° C. for 24 hours. The rod was turned down to an appropriate diameter in a lathe and then tapped using conventional techniques. The white color is due to scattering from incorporated HA particles. Screws such as that depicted in FIG. 3 are designed for fixation and alignment of fractures associated with the ankle, foot, wrist and hand (scale: 1 mm per minor division).

### EXAMPLE 5

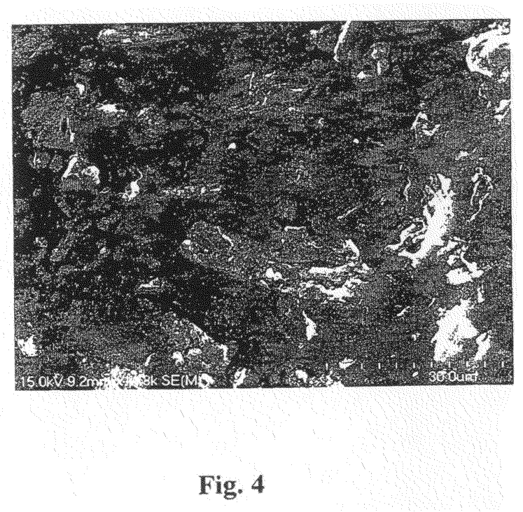

A typical microstructure of HA/PLA composites according to the invention are shown in FIG. 4 (SEM image: HA/PLA mass ratio=½). This sample, which was prepared in the same manner as that used to construct the above screw, was cryofractured at approximately 77 K. The quality of the interface between the embedded HA particles (the bright angular objects) and the surrounding poly-L-lactide is noteworthy. This image provides evidence that a substantial fraction of the initiated polymer chains remain electrostatically attached to the surface of the hydroxyapatite. Given the difference in coefficients of thermal expansion of the bulk materials, fractures might be expected at the interface between the HA and the polylactide if the interactions between the two components were weak.

### EXAMPLE 6

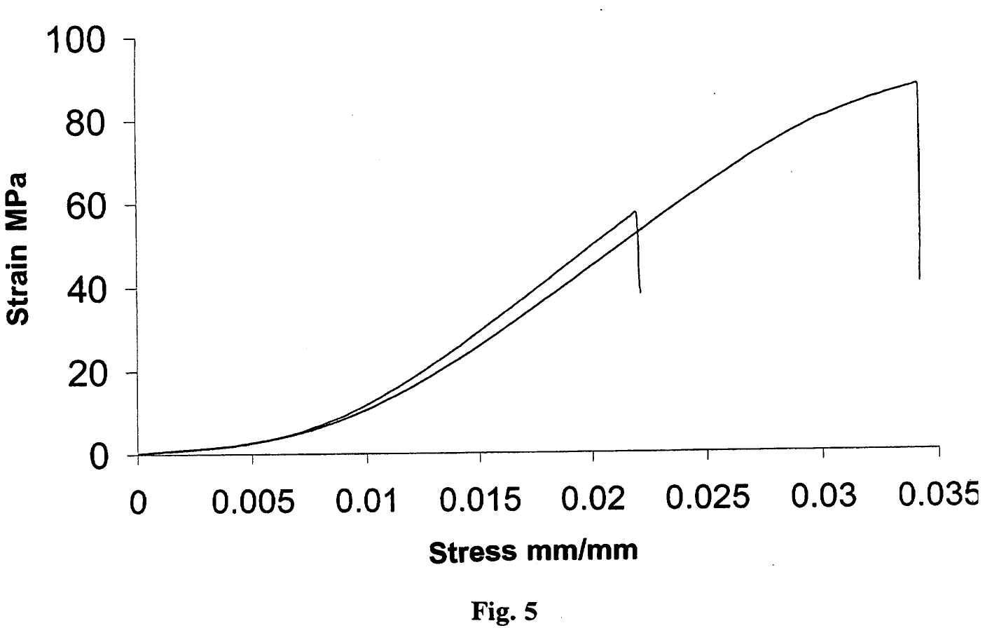

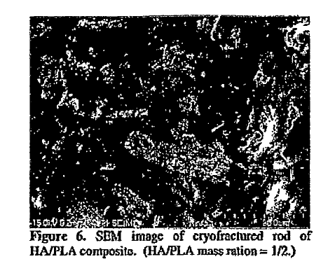

Representative compressive stress-strain curves for HA/polylactide composites are shown in FIG. 5. These measurements were performed on samples that were nominally 6.0 mm in diameter by 10.0 mm in length. All measurements were performed at a crosshead speed of 1.00 mm/min. [blue: HA/polylactide rod prepared from 1:2 ratio of HA/lactide, which was heated at 130° C. for 24 hours; red: HA/polylactide rod prepared from 1:2 ratio of HA:lactide, which was heated at 130° C. for 48 hours]. The modulus for each of these samples and the maximum compressive strain at failure is shown in the Table 1.

TABLE 1

| Sample Description | Modulus | Compressive Strength |
|---|---|---|
| HA:PLA (1:2 ratio by weight) | 3.8 GPa | 87 MPa |
| Polymerized at 130 C. for 24 h | | |
| HA:PLA (1:2 ratio by weight) | 4.0 GPa | 61 MPa |
| Polymerized at 130 C. for 48 h | | |

The values listed in Table 1 are quite impressive. Both the elastic modulus and the compressive strength of the samples of the invention already meets or exceeds values for devices manufactured using other techniques. In fact, the non-optimized samples of the invention are comparable to those obtained using hot-pressed polylactide and hydroxyapatite. For comparative purposes it should be noted that the elastic modulus of polylactide is usually less that 3.0 GPa, while that of cancellous bone ranges from 0.05-0.5 GPa, and cortical bone ranges from 7-30 GPa.

The exact polymerization mechanism involved in the method of the invention is presently unknown. The identity of the reaction that initiates the ring opening process, the mechanism that leads to chain propagation, and what events lead to chain termination are presently also unknown. In fact, given the complexity of the system, there may well be more than one mechanism that contributes to each of these events.

While not wishing to be bound by any theory as to the exact mechanisms of the methods of the invention, some preliminary experimental results have provided some clues concerning the possible polymerization mechanisms. The first attempt at polymerizing lactide with a solid-state initiator involved the use of a surface-modified hydroxyapatite. Hydroxyapatite has well known ion exchange properties. The original hypothesis was that methoxide ions could be exchanged into the surface of hydroxyapatite and that these methoxide ions could serve as the nucleophile to initiate the ring-opening polymerization of lactide (1) to structure (2), which could in turn act as the nucleophile in chain propagation steps that would ultimately lead to polymer (3), as outlined below.

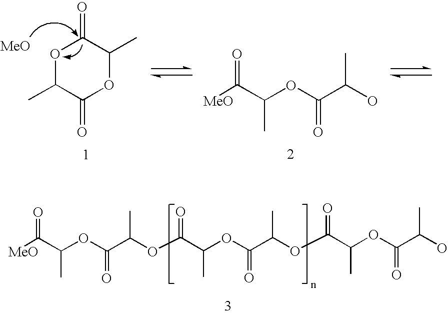

That first experiment using methoxide-exchanged HA to initiate the polymerization of lactide in a melt was successful. A number of subsequent experiments were performed in rapid success to determine the influence of temperature and lactide/HA ratio on the polymerization process. Shortly thereafter, it was decided to run a control. A pure sample of hydroxyapatite, i.e., one that was not exchanged with methoxide, produced a HA/polylactide composite that exhibited physical properties very similar to that observed for the methoxide-exchanged HA. It became clear that the methoxide was not necessary.

Polymer chemists who are familiar with this class of reactions will recall that water can play an important role during ring-opening polymerizations. It is also true that the surface of hydroxyapatite can be quite hydrophilic. Hence, it seemed plausible that surface-bound water might be initiating the polymerization of lactide, not hydroxyapatite. If it is present, water may well play a role as an initiator in this system, but preliminary results clearly demonstrate that the presence of water is not required. The hydroxyapatite used to perform the kinetics experiment shown in FIG. 2, was dried at 400° C. and stored in an inert atmosphere box prior to use. Additionally, before performing any polymerization, the lactide was sublimed to remove water that is frequently present therein when purchased. It seems plausible that water might react with the alkoxide end of 2 or 3 to give an inactive terminal alcohol. It is unclear whether this terminal alcohol might be reactivated in a subsequent reaction with hydroxide ions of HA.

In the following scheme, if hydroxide is the nucleophile that initiates the original ring-opening event to produce 4, it is noteworthy that the carboxylic acid terminus of 4 should react with its own alkoxide terminus, or with the alkoxide terminus of another polymer chain, in (what could be) a chain-terminating step to produce 5.

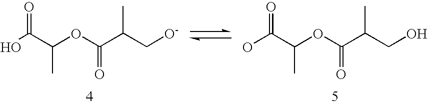

It is possible that 5 might be re-activated in a reaction between the terminal alcohol and a hydroxide in the surface of the hydroxyapatite.

Whatever the mechanistic details ultimately prove to be, preliminary results suggest that the polymerization of cyclic esters, i.e., lactones with apatitic calcium phosphates such as hydroxyapatite is surface initiated, but not completely surface confined. Given that the solubility product of hydroxyapatite is 6.62×10⁻¹²⁶ (when the formula is expressed as Ca₁₀(PO₄)₆(OH)₂), it seems unlikely that a sufficient number of ions could dissolve in the relatively nonpolar lactide melt to initiate the homogenous polymerization at the rates observed. In simple terms, the lactide monomer and the suspended hydroxyapatite are both neutral, and the constraints of electroneutrality mandate that the system stays neutral at each step in the mechanism.

Consequently, in early stages of the polynerization it seems likely that the short polymer chains are tightly associated with the surface through electrostatic interactions. In other words, if an anionic mechanism generates species 2 as shown above, the resulting anionic end of the chain and the remaining cationic surface cannot stray from each other to any appreciable extent; however, this does not preclude the existence of chain transfer steps, which are presently unidentified, from displacing the polymer chain from the surface to give a neutral HA surface and neutral polymer chain in the melt. It seems likely that such chain transfer steps are possible under appropriate conditions. In lieu of such steps it would be impossible to extract polymer from the composite for later characterization by solution phase NMR.

Both glycolide and ε-caprolactone and have been polymerized by ring-opening mechanisms similar to that used above for lactide. Homopolymers of poly-lactide are often quite brittle, but by copolymerizing glycolide and/or ε-caprolactone with lactide, one can gain some control of the mechanical properties and the rates at which the resulting polymers are absorbed in the body.

The hydroxyapatite used herein to polymerize lactide is made by converting brushite (CaHPO₄.2H₂O) to hydroxyapatite as described in the literature. It seems likely that the rate of polymerization will be proportional to the surface area of the HA present in the reaction mixture, not to the number of moles of HA.

Generally, the composites are prepared by polymerizing or copolymerizing the lactone(s) in the presence of the ceramic initiator as a melt, utilizing no solvent. The ceramic may be intimately admixed with the monomer(s) during the polymerization phase to produce a composite with the ceramic as evenly dispersed therein as possible. Alternatively, the ceramic may be arranged in any desired configuration or shape and allowed to polymerize in the presence of the initiating ceramic to produce an article having certain unique desired properties. Generally, temperatures of from about 90° to about 200° C. are sufficient to start the polymerization, which becomes self-sustaining. It will be understood by those skilled in the art, however, that temperatures above and below the above-cited range may be utilized in certain applications, depending upon the particular monomer(s) and initiator employed.

The composites may be formed in molds of virtually any shape to produce an article of the desired shape or configuration or the latter may be obtained by machining and finishing a blank composite having the desired composition.

Generally, the composite contains from about 1% to about 99%, preferably from about 25% to about 60%, by weight, of the ceramic distributed and entrapped within the polymer matrix, depending, of course, upon the properties desired in the end product.

1. A composite comprising a bioabsorbable polymer or copolymer of a lactone monomer or mixture thereof and a ceramic, said composite having been prepared by the ceramic initiated ring-opening polymerization or copolymerization of said lactone monomer, wherein said ceramic is an apatitic calcium phosphate or an osteoconductive, bioabsorbable derivative thereof.

2. A composite of claim 1 wherein said lactone monomer has the formula: 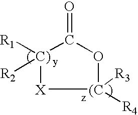
wherein X=nil, —O—, or —O—C═O; z=1-3; y=1-4; R₁-R₄=H—, C₁-C₁₆ straight or branched chain alkyl group, or HOCH₂—, and where all R's are independent on each y or z carbon atom and independent of each other; or 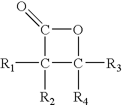
wherein R₁-R₄=H—, C₁-C₁₆ straight or branched chain alkyl group, or HOCH₂—, and where all R's are independent of each other.

3. The composite of claim 2 wherein said monomer is caprolactone, t-butyl caprolactone, zeta-enantholactone, deltavalerolactones, the monoalkyl-delta-valerolactones, e.g., the monomethyl-, monoethyl-, monohexyl-deltavalerolactones, and the like; the nonalkyl, dialkyl, and trialkyl-epsilon-caprolactones, e.g., the monomethyl-, monoethyl-, monohexyl-, dimethyl-, di-n-propyl-, di-n-hexyl-, trimelhyl-, triethyl-, tri-n-epsilon-caprolactones, 5-nonyl-oxepan-2-one, 4,4,6- or 4,6,6-trim ethyl-oxepan-2-one, 5-hydroxymethyl-oxepan-2-one, and the like; beta-lactones, e.g., beta-propiolactone, beta-butyrolactone gamma-lactones, e.g., gammabutyrolactone or pivalolactone, dilactones, e.g., lactide, dilactides, glycolides, e.g., tetramethyl glycolides, alkyl derivatives thereof and the like, ketodioxanones, e.g., 1,4-dioxan-2-one, 1,5-dioxepan-2-one, and the like.

4. A composite of claim 3 wherein said composite comprises a polymer or copolymer of lactide and one or more monomers that copolymerize therewith to form an osteoconductive, bioabsorbable polymer, said composite having been prepared by the said ring-opening copolymerization of lactide with said one or monomers.

5. A composite of claim 1 wherein said composite contains from about 1% to about 99%, by weight, of said ceramic, distributed throughout and entrapped by said polylactide polymer or copolymer.

6. A composite of claim 5 wherein said composite contains from about 25% to about 60%, by weight, of said ceramic.

7. A composite of claim 1 wherein said ceramic is hydroxyapatite.

8. A composite of claim 1 wherein said ceramic is an OH-exchanged hydroxyapatite capable of initiating ring-opening polymerization of said lactone.

9. The composite of claim 8 wherein said exchanged hydroxyapatite is oxide-, alkoxide- or alkonoic acid-exchanged hydroxyapatite.

10. The composite of claim 9 wherein said alkoxide is methoxide or ethoxide.

11. The composite of claim 9 wherein said alkanoic acid is octanoic acid.

12. A method of preparing a composite comprising a bioabsorbable polymer or copolymer of a lactone monomer or mixtures thereof and a ceramic, comprising polymerizing or copolymerizing said lactone monomer by ring-opening polymerization initiated by said ceramic, wherein said ceramic is an apatitic calcium phosphate or an osteoconductive, bioabsorbable derivative thereof.

13. The method of claim 12 wherein said lactone monomer has the formula: 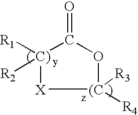
wherein X=nil, —O—, or —O—C═O; z=1-3; y=1-4; R₁-R₄=H—, C₁-C₁₆ straight or branched chain alkyl group, or HOCH₂—, and where all R's are independent on each y or z carbon atom and independent of each other; or 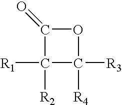
wherein R₁-R₄=H—, C₁-C₁₆ straight or branched chain alkyl group, or HOCH₂—, and where all R's are independent of each other.

14. The method of claim 13 wherein said lactone monomer is caprolactone, t-butyl caprolactone, zeta-enantholactone, deltavalerolactones, the monoalkyl-delta-valerolactones, e.g., the monomethyl-, monoethyl-, monohexyl-dellavalerolactones, and the like; the nonalkyl, dialkyl, and trialkyl-epsilon-caprolactones, e.g., the monomethyl-, monoethyl-, monohexyl-, dimethyl-, di-n-propyl-, di-n-hexyl-, trimethyl-, triethyl-, tri-n-epsilon-caprolactones, 5-nonyl-oxepan-2-one, 4,4,6- or 4,6,6-trimethyl-oxepan-2-one, 5-hydroxymethyl-oxepan-2-one, and the like; beta-lactones, e.g., beta-propiolactone, beta-butyrolactone gamma-lactones, e.g., gammabutyrolactone or pivalolactone, dilactones, e.g., lactide, dilactides, glycolides, e.g., tetramethyl glycolides, alkyl derivatives thereof and the like, ketodioxanones, e.g., 1,4-dioxan-2-one, 1,5-dioxepan-2-one, and the like.

15. The method of claim 14 wherein said composite comprises a polymer of or a copolymer of lactide and one or monomers that polymerize therewith to form an osteoconductive, bioabsorbable polymer, and said ring-opening polymerization of lactide is conducted in the presence of said one or monomers.

16. The method of claim 12 wherein said composite contains from about 1% to about 99%, by weight, of said ceramic, substantially homogenously distributed throughout and entrapped by said polylactide polymer or copolymer.

17. The method of claim 16 wherein said composite contains from about 25% to about 60%, by weight, of said ceramic.

18. The method of claim 12 wherein said ceramic is hydroxyapatite.

19. The method of claim 12 wherein said ceramic is an exchanged hydroxyapatite capable of initiating ring-opening polymerization of said lactone.

20. The method of claim 19 wherein said exchanged hydroxyapatite is oxide-, alkoxide- or alkonoic acid-exchanged hydroxyapatite.

21. The method of claim 19 wherein said alkoxide is methoxide or ethoxide.

22. The method of claim 20 wherein said alkanoic acid is octanoic acid.

23. An article of manufacture comprising the composite of claim 1.

24. The article of manufacture of claim 18 comprising a bioprosthesis or bone fixation device.

25. The article of claim 24 wherein said bone fixation device is a pin, screw, bar or plate.
